(19) United States
(12) Patent Application Publication
(10) Pub. No.: US 2011/0149983 A1
(43) Pub. Date: Jun. 23, 2011

(54) AMI GATEWAY APPARATUS FOR PROCESSING LARGE AMI DATA AND VARIOUS APPLICATION PROFILES AND METHOD THEREOF

(75) Inventors: Tae Wook HEO, Daejeon (KR); Jong Arm Jun, Daejeon (KR); Sang Gi Hong, Daejeon (KR); Jong Suk Chae, Daejeon (KR)

(73) Assignee: Electronics and Telecommunications Research Institute, Daejeon (KR)

(21) Appl. No.: 12/961,545

(22) Filed: Dec. 7, 2010

(30) Foreign Application Priority Data
Dec. 21, 2009 (KR) 10-2009-0127697
Mar. 22, 2010 (KR) 10-2010-0025355

(51) Int. Cl. H04L 12/56

(52) U.S. Cl. 370/401

(57) ABSTRACT

Provided are an AMI gateway apparatus and method for processing large AMI data and an application profile. The AMI gateway apparatus and method are associated with collecting meter data of smart meters measuring the amount of electricity or the like and transmitting the meter data to an AMI server. Disclosed is a method of reducing an ID type and a method of minimizing meter data to reduce the transmission rate of large AMI data including an ID value and meter data. A method of setting a gateway ID value according to locations and zones is also provided. Those three methods achieve the efficient transmission of large AMI data to an AMI server and is applicable to various gateway apparatuses processing various application profiles such as an HA profile controlling and sensing home appliances, an SE profile providing an AMI service, a TA profile providing mobile services or the like.

### CROSS-REFERENCE TO RELATED APPLICATIONS

This application claims priority under 35 U.S.C. §119 to Korean Patent Application No. 10-2009-0127697, filed on Dec. 21, 2009 and Korean Patent Application No. 10-2010-0025355, filed on Mar. 22, 2010 in the Korean Intellectual Property Office, the disclosure of which are incorporated herein by reference in its entirety.

### TECHNICAL FIELD

The following disclosure relates to an Advanced Metering Infrastructure (AMI) gateway apparatus for processing large AMI data and various application profiles and a method thereof, and in particular, to an AMI gateway apparatus for processing large AMI data and various application profiles to collect data of meters and transmit the data to an AMI server, and a method thereof.

### BACKGROUND

A metering processing method in one-way communications according to the related art is aimed at collecting and sending meter data, and the meter data is collected and sent, usually once in 24 hours. However, this method is inadequate to process meter data in two-way communications.

In order to process Advanced Metering Infrastructure (AMI) data, data needs to be collected at short intervals of 15 minutes to 1 hour and be quickly sent to a server. In addition, a control message from a server needs to be created and processed, which brings about a need for another method to process data.

Also, gateway technologies for performing independent gateway functions have been developed, and studies are ongoing to easily integrate and convert those functions. In this regard, a method for enabling easy application of service profiles, specified by ZigBee, such as smart energy profiles or Telecom Application (TA) profiles, needs to be provided additionally.

### SUMMARY

In one general aspect, an Advanced Metering Infrastructure (AMI) gateway apparatus includes: a storage storing a second Identification (ID) value as a mapping table, the second ID value having a smaller data size than a first ID value, which identifies a meter, and mapped with the first ID value; an ID data processing unit converting the first ID value into the second ID value on the basis of the mapping table; a meter data processing unit calculating an increase in the meter value; and a processor receiving the second ID value and the increase in the meter value and transmitting the received second ID value and the increase in the meter value to an AMI server.

In another general aspect, an Advanced Metering Infrastructure (AMI) gateway apparatus includes: a storage storing a second Identification (ID) value and zone information corresponding to a gateway ID, the second ID value having a smaller data size than a first ID value, which identifies a meter, and mapped with the first ID value; an ID value processing unit converting the first ID value into the second ID Value by using the mapping table, and classifying the converted second ID value according to the zone information; a meter value processing unit calculating an increase in the meter value according to the zone information; and a processor processing various control messages and transmitting the second ID value and the increase in the meter value to an AMI server as large AMI data.

In still another general aspect, a method of processing large Advanced Metering Infrastructure (AMI) data, includes: establishing a second Identification (ID) value in the form of a mapping table, the second ID value having a smaller data size than a first ID value, which identifies a meter, and mapped with the first ID value; converting, by an ID data processing unit, the first ID value into the second ID value by using the mapping table; calculating, by a meter data processing unit, an increase in the meter value; and transmitting, by a processor which processes various control messages, the second ID Value and the increase in the meter value to an AMI server as large AMI data.

Other features and aspects will be apparent from the following detailed description, the drawings, and the claims.

### BRIEF DESCRIPTION OF THE DRAWINGS

FIG. 1 is a block diagram illustrating the entire configuration of an apparatus for distributed processing of large AMI data according to an exemplary embodiment.

FIGS. 2 and 3 illustrate packet structures of large AMI data transmitted to an AMI server through an AMI gateway depicted in FIG. 1.

FIG. 4 is a block diagram illustrating the entire configuration of an apparatus for distributed processing of large AMI data depicted in FIG. 1.

FIG. 5 is a block diagram illustrating the entire configuration of an apparatus for distributed processing of large AMI data depicted in FIG. 1.

FIG. 6 is a block diagram illustrating a typical AMI gateway apparatus.

FIG. 7 is a configuration view illustrating a gateway apparatus for processing large MAI data and various application profiles according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

An apparatus for distributed processing of large AMI data and a method thereof will now be described in detail with reference to accompanying drawings.

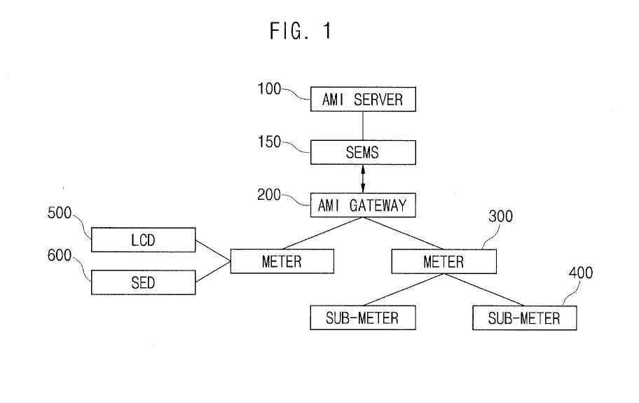

FIG. 1 is a block diagram illustrating the entire configuration of an apparatus for distributed processing of large AMI data according to an exemplary embodiment.

Referring to FIG. 1, the apparatus for distributed processing of large AMI data, according to an exemplary embodiment, includes an AMI server 10, a Smart Energy Management Server (SEMS) 150, an AMI gateway 200, a meter 300, a sub-meter 400, a Liquid Crystal Display (LCD) 500 and a Surface-conduction Electron-emitter Display (SED) 600 having an In-Home-Device (IHD) function.

First, the meter 300 measures the amount of electricity, for example, the amount of electricity used for an entire building. As shown in FIG. 1, a plurality of meters 300 may be provided.

The sub-meter 400 measures the amount of electricity in the outlet unit of a single house, and supports the sub-function of the meter 300. For example, the sub-meter 400 measures the amount of electricity used for an individual room of a single house. To this end, a plurality of sub-meters 400 may be provided as illustrated in the drawing.

The LCD 500 is connected to the meter 300, and provides an interface screen for power ON/OFF control and differential power control.

The SED 600 is connected to the meter 400, and displays the remaining amount of energy and a load control signal.

The above-mentioned devices, represented by the reference numerals 300, 400, 500 and 600, are connected to the AMI gateway 200 via a wired/wireless network, for example, via Power Line Communication (PLC) and ZigBee wireless network.

The AMI gateway 200 collects meter data by using the meters 300, and transmits the collected meter data to the SEMS 150 and the AMI server 100. The AMI gateway 200 quickly sends collected large AMI data to the AMI server 100 by reducing the data rate of the AMI data, containing ID values and meter values, on the basis of a format structure proposed by this exemplary embodiment. That is, when an ID value and a meter value do not fluctuate, the AMI data is not transmitted to the AMI server 100. As a result, the collected large AMI data can be quickly sent to the AMI server 100. In addition, the AMI gateway 200 assigns an ID value according to the zone of a gateway ID. Accordingly, an operator can easily identify the zone of AMI data being collected and processed in a distributed manner, and can locate a corresponding AMI gateway 200 (e.g., Gajeong-district, Yuseong-ward, Daejeon, Korea) by using a mapping table established in the AMI gateway.

The SEMS 150 and the AMI server 100 create a variety of control messages. The AMI gateway 200 transmits the created various control messages to the LCD 500, the SED 600 or the like.

The AMI server 100 collects and stores meter data measured by each meter 300.

The SEMS 150 stores meter data sent through the AMI gateway 200 within a unit area such as an apartment, a building or the like, and manages the amount of energy.

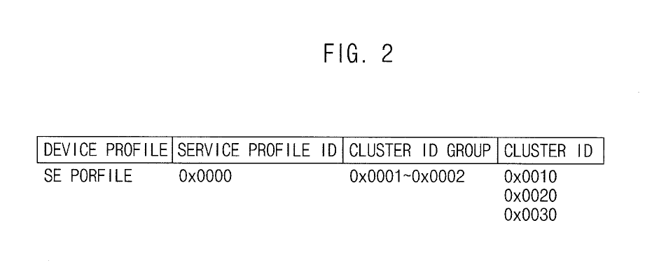

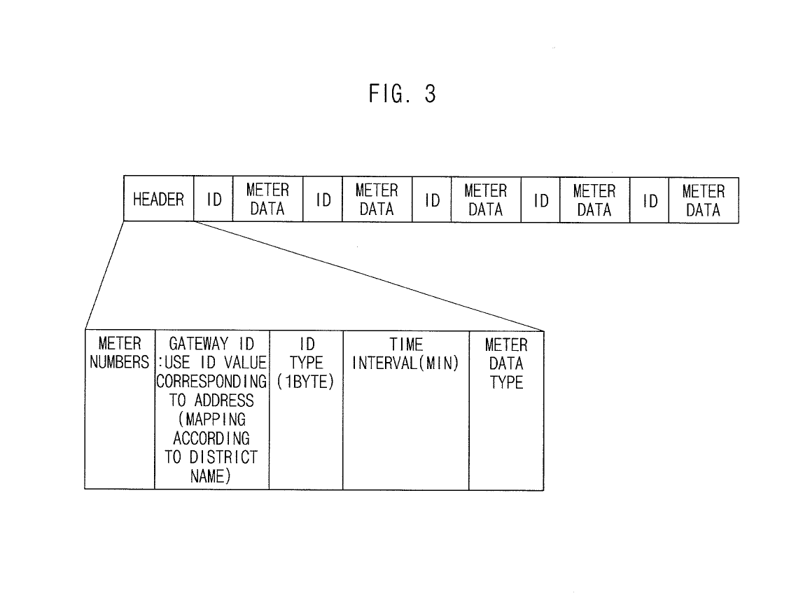

FIGS. 2 and 3 depict the packet structure of AMI data sent to the AMI server and the SEMS through the AMI gateway depicted in FIG. 1.

The packet structures, shown in FIGS. 2 and 3, allow for the reduction of the data rate of AMI data from the AMI gateway 200 to the AMI server 100.

As shown in FIG. 2, the packet structure includes a header, IDs, and meter data. The header defines five items, namely, meter numbers, a gateway ID, an ID type, a time interval and a meter data type.

This exemplary embodiment teaches two transmission methods to reduce the data rate of AMI data on the basis of the above packet structure.

The first transmission method to reduce the data rate of AMI data involves with transmitting AMI data after adjusting ID values. Here, an ID value refers to the identification information of a meter, and may be specified in bytes.

As for the transmission method allowing for the reduction of ID values, there are a method of eliminating an ID value, a method of using 2 bytes or 4 bytes available in an ID value, a method of using the entirety of an ID value, a method of using a mapping table, and a method of converting an ID values into a string and a number by using a mapping table.

First, in the method of eliminating an ID value, an ID value is arranged in order, thereby eliminating an ID.

The method of using 2 bytes or 4 bytes available in an ID value adopts a method of transmitting the lowest 2 or 4 bytes of a Media Access Control (MAC) address contained in an ID value. In the method of transmitting the lowest 2 bytes of a MAC address, only the lowest 2 bytes in a MAC address of an ID value are changed. In the method of transmitting the lowest 4 bytes, only the lowest 4 bytes in a MAC address of an ID value are changed.

The method of using the entirety of an ID value uses an ID value itself as a MAC address.

The method of using a mapping table adopts a method of using an ID value as the ID value of the minimum byte according to a meter number on the basis of a mapping table. In this case, an inquiry process of asking for a list is performed, and then an aliasing method is applied thereto.

The method of converting an ID value into a string and a number by using a mapping table adopts a method of converting an ID value into an identifiable string or number having a length, defined by a user, by referring to a mapping table.

As for the second transmission method to reduce the data rate of AMI data, there are a method of not sending meter data (hereinafter referred to as a “meter value” when there is no change in the meter value, a method of transmitting a meter value as it is, a method of transmitting only an increase in a meter value, a method of transmitting only a difference value in a meter value obtained by a linear prediction algorithm, a method of transmitting only a difference value in a meter value obtained by a two-dimensional prediction algorithm, and a method of transmitting only a differential value in a meter value obtained by a three-dimensional prediction algorithm.

As for the method of not transmitting the meter value, the meter value is not transmitted when there is no change in a meter value.

As for the method of transmitting only an increase in a meter value, when an increase in the meter value is transmitted, an integer value obtained by ten-folding one decimal place of the increase is transmitted, or an integer value obtained by centuplicating two decimal places of the increase is transmitted.

In the method of transmitting a meter value as only a difference value by using a linear prediction algorithm, the meter value is transmitted as a difference value obtained by a linear prediction algorithm expressed by a linear equation, for example, a linear prediction of y=ax+b.

As for the method of transmitting a meter value as only a difference value by using a two-dimensional prediction algorithm, a meter value is transmitted as a differential value obtained by a prediction algorithm expressed by a quadratic equation, for example, a quadratic prediction algorithm of y=ax̂2+bx+c.

In the method of transmitting a meter value as only a difference value by using a third-dimensional prediction algorithm, a meter value is transmitted as a differential value obtained by a prediction algorithm expressed by a cubic equation, for example, a cubic prediction algorithm of y=ax̂3+bx̂2+cx+d.

In addition, equations corresponding to various prediction algorithms may be used.

According to this exemplary embodiment, a method of setting a gateway ID value according to a zone is proposed. This may facilitate the mapping of the ID value with an administrative zone. As shown in FIG. 3, a gateway ID value is set according to a zone to thereby facilitate a classifying process. That is, since an ID value is set by a zone, a control message being sent from the AMI server 100 to the meter 300 may be classified on the basis of the gateway ID value.

The method of setting a gateway ID value according to a zone is as follows:

1) Setting a gateway ID according to a zone

2) Metropolitan City/Province (limited to 32)

3) Ward/City/County (limited to 128)

4) District/District/Town (Eup in Korean) (limited to 128)

5) Setting an ID set by the application of up to districts, +16 Bit gateway ID value

### EXAMPLE

### Daejeon Metropolitan City (1/32), Yuseong ward (1/128), Gajeong District (1/128)

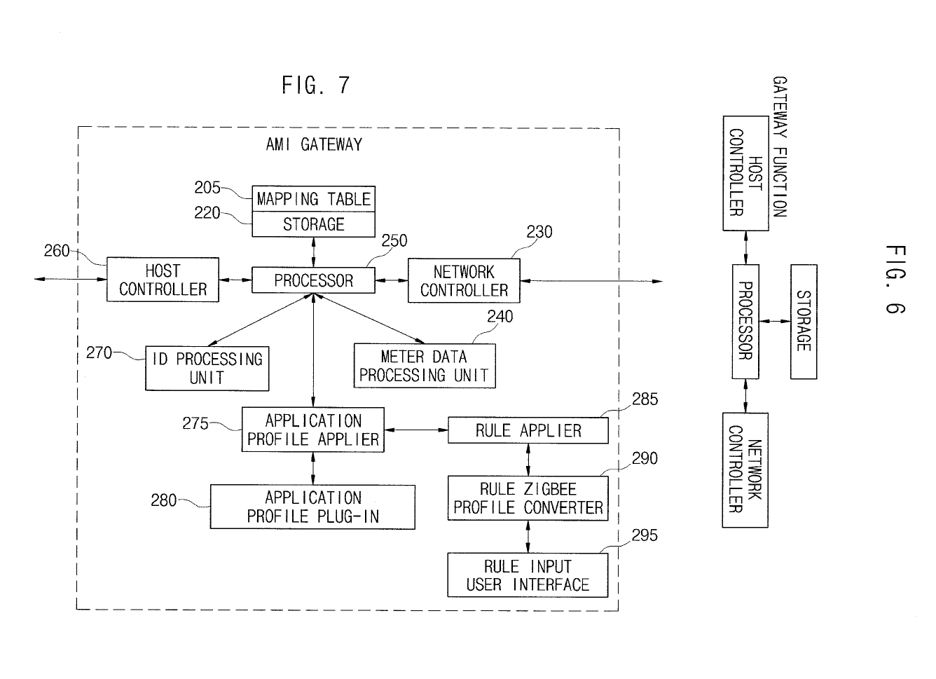

An exemplary embodiment proposes a structure allowing for the easy application of an application file service. This may significantly increase the efficiency of an AMI gateway. That is, a structure allowing for the easy application of an application file service through an XML interface (i.e., a Rule input user interface shown in FIG. 7) is suggested. In order to achieve the easy application of various services, an exemplary embodiment proposes a method by which the easy application of, for example, a ZigBee service profile, such as a Smart Energy Profile, an HA profile, a TA profile or the like is achieved, and a desired service is easily established. This structure that allows for the easy application of an application file service will be described with reference to FIG. 7.

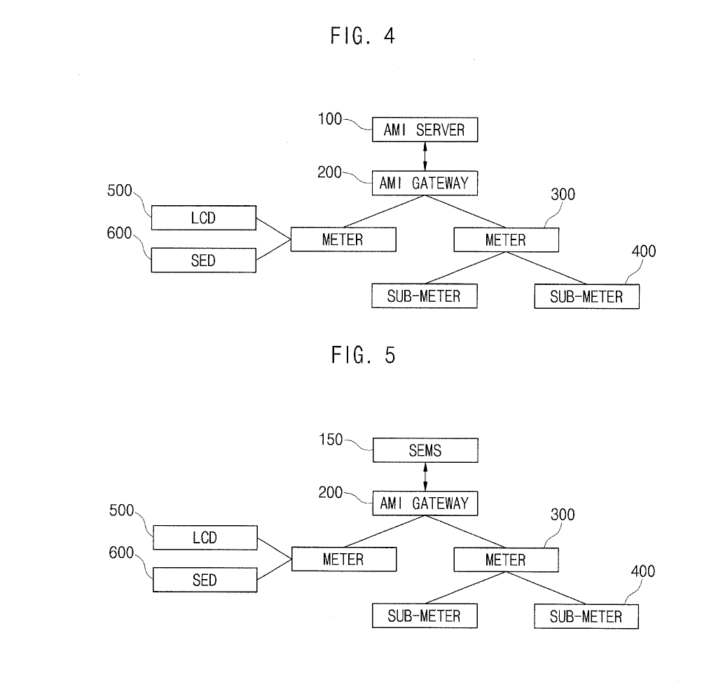

FIG. 4 is a block diagram illustrating the entire configuration of an apparatus for distributed processing of large AMI data according to another exemplary embodiment.

The apparatus for distributed processing of large AMI data, shown in FIG. 4, does not include the SEMS 150 depicted in FIG. 1, and is different from the apparatus shown in FIG. 1 in that the AMI server 100 of FIG. 4 is connected directly to the AMI gateway and thus receives large AMI data from the AMI gateway.

FIG. 5 is a block diagram illustrating the entire configuration of an apparatus for distributed processing of large AMI data according to another exemplary embodiment.

The apparatus for distributed processing of large AMI data, shown in FIG. 5, does not include the AMI server 100 depicted in FIG. 1, and is different from the apparatus shown in FIG. 1 in that the AMI gateway 200 transmits AMI data to only the SEMS 150.

FIG. 6 is a block diagram illustrating a typical AMI gateway apparatus.

Referring to FIG. 6, the AMI gateway apparatus has a structure connected to an IP (Internet Protocol) network, ZigBee and PLC. The AMI gateway apparatus includes a host controller processing an IP network, and a network controller processing ZigBee and PLC networks. The AMI gateway apparatus also includes a storage for storing data, and the like.

FIG. 7 is a block diagram illustrating one example of the internal configuration of the AMI gateway apparatus shown in FIG. 3.

Referring to FIG. 7, an AMI gateway apparatus according to an exemplary embodiment includes a storage 220 storing a mapping table 205 in order to reduce the data rate of AMI data being sent to the AMI server 100, a network controller 230, a meter process processing unit 240, a processor 250, a host controller 260 and an ID processing unit 270.

The AMI gateway apparatus according to an exemplary embodiment has a structure allowing for the easy application of an application file service, thereby enhancing the efficiency of a gateway. To this end, the AMI gateway apparatus according to an exemplary embodiment further includes an application profile plug-in 280, a rule applier 285, a rule ZigBee profile converter 290, and a rule input user interface 295.

In order to reduce the transmission rate of AMI data, the storage 220 configured in the AMI gateway apparatus includes a mapping table 205 for mapping an ID value and a gateway ID value.

The network controller 230 is a controller processing ZigBee and PLC functions. This network controller 230 is connected to an adjacent sensor network and receives data of another network.

The meter data processing unit 240 periodically receives meter values from meters, and calculates an increase in the received meter value according to a packet structure described with reference to FIGS. 2 and 3.

The host controller 260 is connected to the AMI server 100 and the SEMS 150 via a wired/wireless IP network, and transmits the increase in the meter value and the second ID value from the processor 250 to the AMI server 100 via the SEMS 150.

The ID data processing unit 270 is a processor for reducing the ID value, and converts a first ID value into a second ID value, which is smaller than the first ID value, by using the mapping table 205.

The processor 250 processes various control messages, and sends the second ID value and an increase in the meter value to the host controller 260 in order to transmit the second ID value and the increase in the meter value to the AMI server.

In order to easily apply a service profile, the rule input user interface 295 configured in the AMI gateway apparatus receives a service profile via web and dedicated GUI.

The AMI gateway apparatus according to an exemplary embodiment may further include the following configurations in order to process various application profiles.

In order to use a specific service profile such as a profile called home automation (hereinafter referred to as a “HA profile”), the rule input user interface 295 receives the specific service profile according to a cluster, a command and an attribute value associated with the specific service profile. The HA profile refers to a profile providing a home automation service, and exists in ZigBee. An existing profile is processed by the application profile plug-in or tan adaptor. Other profiles are processed by Web GUI or an application setting screen. When an air conditioner is connected to a device including a temperature sensor, a rule that the air conditioner be operated when the temperature of the temperature sensor is 25 degrees or higher is input to the rule input user interface 295.

When the rule is input by a user definition, the rule ZigBee profile converter 290 converts the rule according to ZigBee, a cluster, an attribute and a command.

The rule applier 285 applies the rule, converted according to the ZigBee, cluster, attribute and command, to the gateway.

The application profile applier 275 includes the function of the rule applier and communicates with the processor 250.

When a profile supported by existing ZigBee is input, the adaptor 280 recognizes a device that inputs the profiles as an adaptor. When a profile is provided in advance, the adaptor 280 plugs in an application profile by using a schema file such as xsd and a data file such as xml.

The configurations 205, 220, 230, 240, 250, 260 and 270 of the AMI gateway apparatus for reducing the transmission rate of AMI data, and the configurations 275, 280, 285, 290 and 295 for the easy application of a service profile may be implemented within the AMI gateway apparatus according to an exemplary embodiment, or may be separately implemented.

When an application profile created in the above manner is applied, the AMI gateway may support not only an AMI profile support service but also an HA profile support service.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Advanced Metering Infrastructure (AMI) gateway apparatus comprising:
a storage storing a second Identification (ID) value as a mapping table, the second ID value having a smaller data size than a first ID value, which identifies a meter, and mapped with the first ID value;
an ID data processing unit converting the first ID value into the second ID value on the basis of the mapping table;
a meter data processing unit calculating an increase in the meter value receiving from the meter; and
a processor receiving the second ID value and the increase in the meter value and transmitting the received second ID value and the increase in the meter value to an AMI server.

2. The AMI gateway apparatus of claim 1, wherein the ID data processing unit transmits only the lowest bytes of a Media Access Control (MAC) address included in the first ID value to the processor.

3. The AMI gateway apparatus of claim 2, wherein the lowest bytes are more than 2 bytes.

4. The AMI gateway apparatus of claim 1, wherein the ID data processing unit converts the first ID value into the second ID value of the minimum bytes mapped with the first ID value by using the mapping table, and transmitting the second ID value to the processor.

5. The AMI gateway apparatus of claim 1, wherein the ID data processing unit converts the first ID value into a string or a number by using the mapping table, and transmitting the converted string or number to the processor as the second ID value.

6. The AMI gateway apparatus of claim 1, further comprising a network controller connected to the processor, processing ZigBee and Power Link Communication (PLC) functions, and connected to an adjacent sensor network.

7. The AMI gateway apparatus of claim 1, further comprising a host controller performing data communication with the AMI server via a wired/wireless Internet Protocol (IP) network,
wherein the processor transmits the second ID value and the increase in the meter value to the AMI server through the host controller.

8. The AMI gateway apparatus of claim 1, further comprising:
a rule input user interface receiving a rule corresponding to a specific service profile according to a cluster, a command and an attribute value related to the specific service profile to receive the specific service profile existing in ZigBee;
a rule ZigBee profile converter converting the rule according to a ZigBee cluster, an attribute and a command;
a rule applier applying the rule, converted according to the ZigBee cluster, the attribute and the command, to a gateway; and
an application profile applier including a function of the rule applier and communicating with the processor.

9. The AMI gateway apparatus of claim 8, wherein the ZigBee service profile is a smart energy profile, a Home Automation (HA) profile or a Telecom Application (TA) profile.

10. An Advanced Metering Infrastructure (AMI) gateway apparatus comprising:
a storage storing a second Identification (ID) value and zone information corresponding to a gateway ID, the second ID value having a smaller data size than a first ID value, which identifies a meter, and mapped with the first ID value;
an ID value processing unit converting the first ID value into the second ID Value by using the mapping table, and classifying the converted second ID value according to the zone information;
a meter value processing unit calculating an increase in the meter value according to the zone information; and
a processor processing various control messages and transmitting the second ID value and the increase in the meter value to an AMI server as large AMI data.

11. A method of processing large Advanced Metering Infrastructure (AMI) data, the method comprising:
establishing a second Identification (ID) value in the form of a mapping table, the second ID value having a smaller data size than a first ID value, which identifies a meter, and mapped with the first ID value;
converting, by an ID data processing unit, the first ID value into the second ID value by using the mapping table;
calculating, by a meter data processing unit, an increase in the meter value; and
transmitting, by a processor which processes various control messages, the second ID Value and the increase in the meter value to an AMI server as large AMI data.

12. The method of claim 11, wherein the converting of a second ID value comprises converting the lowest bytes of a Media Access Control (MAC) address included in the ID value into the second ID value.

13. The method of claim 12, wherein the lowest bytes are more than 2 bytes.

14. The method of claim 11, wherein the converting of a second ID value comprises converting the first ID value into the second ID value of the minimum bytes mapped with the first ID value by using the mapping table.

15. The method of claim 11, wherein the converting of a second ID value comprises converting the first ID value into a string or a number by using the mapping table.

16. The method of claim 11, wherein the calculating of an increase in the meter value comprises using a prediction algorithm, expressed by a linear equation, to calculate a difference value, obtained by the linear equation, as an increase in the meter value.

17. The method of claim 11, wherein the calculating of an increase in the meter value comprises using a prediction algorithm, expressed by a quadratic equation, to calculate a difference value, obtained by the quadratic equation, as an increase in the meter value.

18. The method of claim 11, wherein the calculating of an increase in the meter value comprises using a prediction algorithm, expressed by a cubic equation, to calculate a difference value, obtained by the cubic equation, an increase in the meter value.
